(19) United States
(12) Patent Application Publication
(10) Pub. No.: US 2026/0062645 A1
(43) Pub. Date: Mar. 5, 2026

(54) LAUNDRY DETERGENT COMPOSITION

(71) Applicant: THE PROCTER & GAMBLE COMPANY, Cincinnati, OH (US)

(72) Inventors: Xiaohan WANG, Beijing (CN); Yuzhu YIN, Beijing (CN); Keyu GENG, Beijing (CN); Ming TANG, Beijing (CN); Yanli ZHANG, Beijing (CN)

(21) Appl. No.: 19/315,976

(22) Filed: Sep. 2, 2025

(30) Foreign Application Priority Data
Sep. 3, 2024 (WO) PCT/CN2024/116543

(51) Int. Cl. C11D 1/00; C11D 1/14; C11D 1/74; C11D 3/00

(52) U.S. Cl. CPC C11D 1/008; C11D 1/146; C11D 1/74; C11D 3/0021

(57) ABSTRACT

A laundry detergent composition comprising a dye fixative, a cleaning polymer, and a surfactant system.

### FIELD OF THE INVENTION

The present invention relates to a laundry detergent composition comprising a dye fixative, a cleaning polymer, and a surfactant system.

### BACKGROUND OF THE INVENTION

As detergent products are evolving, consumer needs in the term of cleaning have been well met. However, there are still some other unmet consumer needs in the field of laundry. Particularly, one of the unmet needs is to provide an improved whiteness for light-colored clothing, especially white shirts or socks, after washing.

Fluorescent brighteners have been widely used in laundry detergent compositions. However, consumers are becoming to have more and more concerns about potential risks related to the use of fluorescent brighteners. There is therefore a continuing need for laundry detergent compositions that are capable of providing an improved whiteness for light-colored clothing in the absence of fluorescent brighteners.

Cleaning polymers and dye fixatives are known and have been used in laundry compositions to respectively help the cleaning performance and address the dye transfer problem. However, it is unknown if the combination of cleaning polymers and dye fixatives is synergistic in whitening performance.

### SUMMARY OF THE INVENTION

It was surprisingly discovered by the present inventors that the combination of a cleaning polymer and a dye fixative in a detergent formulation is synergistic in whitening performance. Particularly, the combination of a cleaning polymer and a dye fixative can deliver a significantly improved whitening performance than when the cleaning polymer and the dye fixative are used alone.

Correspondingly, the present invention in one aspect relates to a laundry detergent composition, comprising:
a) from 0.01% to 10%, by weight of the composition, of a dye fixative wherein said dye fixative is selected from the group consisting of reaction products of amines with epichlorohydrin in which the amines are primary, secondary or tertiary amines;
b) from 0.01% to 10%, by weight of the composition, of a cleaning polymer wherein said cleaning polymer is selected from the group consisting of a polyalkylene imine polymer, a polyalkylene oxide polymer, and any combinations thereof;
c) from 0.1% to 70%, by weight of the composition, of a surfactant system,
wherein the polyalkylene imine polymer comprises a core structure and a plurality of alkoxylate groups, wherein:
   the core structure comprises
i) a polyalkylenimine structure comprising, in condensed form, repeating units of formulae (I), (II), (III) and (IV):

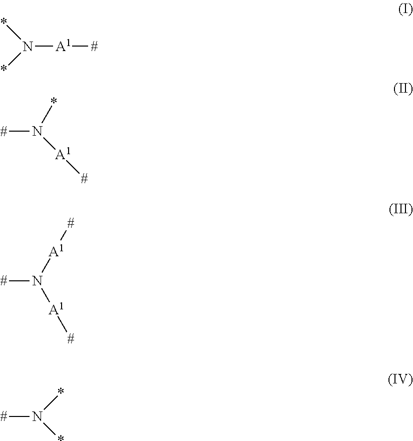

wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol; or
ii) a polyalkanolamine structure of the condensation products of at least one compound selected from N-(hydroxyalkyl)amines of formulae (I.a) and/or (I.b),

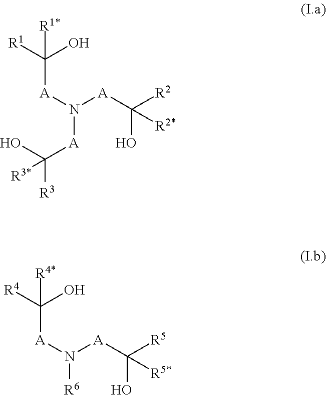

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted; and
the plurality of alkylenoxy groups are independently selected from alkylenoxy units of the formula (V)

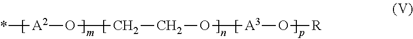

wherein: * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 10 to about 50; and p has an average value in the range of from about 10 to about 50,
wherein said polyalkylene oxide polymer is a polyalkylene graft copolymer comprising polyalkylene oxide component as a graft base, which has a number average molecular weight of from 1000 to 20,000 Daltons and is based on ethylene oxide, propylene oxide, butylene oxide or mixtures thereof, and polyvinyl ester component and/or polyvinyl five-membered nitrogen heterocycle component as side chains.

In some embodiments, said dye fixative is selected from the group consisting of reaction products of dimethylamine with epichlorohydrin. Preferably, said dye fixative is poly(2-hydroxypropyldimethylammonium chloride).

In some embodiments, said dye fixative is present in an amount ranging from 0.02% to 5%, preferably from 0.05% to 4%, more preferably from 0.1% to 3%, most preferably from 0.15% to 2%, by weight of the composition.

In some embodiments, said cleaning polymer is present in an amount ranging from 0.02% to 5%, preferably from 0.05% to 4%, more preferably from 0.1% to 3%, most preferably from 0.15% to 2%, by weight of the composition.

In some embodiments, said surfactant system is present in an amount ranging from 1% to 45%, preferably from 2% to 40%, more preferably from 3% to 35%, most preferably from 4% to 30%, by weight of the composition.

In some embodiments, said surfactant system comprises an anionic surfactant and/or a non-ionic surfactant. Preferably, the anionic surfactant is selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof, and/or the nonionic surfactant is selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof. More preferably, the anionic surfactant comprises C₆-C₂₀ linear alkylbenzene sulfonates (LAS) and/or C₆-C₂₀ alkyl alkoxy sulfates, and/or the nonionic surfactant comprises a C₆-C₂₀ alkoxylated alcohol having a weight average degree of alkoxylation ranging from 1 to 20, preferably from 5 to 15, more preferably from 7 to 10.

In some embodiments, the non-ionic surfactant is present as a main surfactant, preferably as a majority surfactant.

In some embodiments, said composition is a liquid composition or a unit dose composition.

In another aspect, the present invention relates to a method of whitening a light-colored fabric comprising contacting the fabric with the laundry detergent composition as mentioned hereinabove.

In another aspect, the present invention relates to use of the laundry detergent composition for whitening a light-colored fabric.

It is an advantage of the laundry detergent composition to deliver an effective whitening for light-colored fabrics.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “laundry detergent composition” means a composition for cleaning soiled materials, including fabrics. Such compositions may be used as a pre-laundering treatment, a post-laundering treatment, or may be added during the rinse or wash cycle of the laundering operation. The laundry detergent composition compositions may have a form selected from liquid, powder, unit dose such as single-compartment or multi-compartment unit dose, pouch, tablet, gel, paste, bar, or flake. Preferably, the laundry detergent composition is a liquid or a unit dose composition. The term of “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof. The term of “unit dose laundry detergent composition” herein refers to a water-soluble pouch containing a certain volume of liquid wrapped with a water-soluble film.

As used herein, the term “main surfactant” refers to a surfactant that is present in a composition at an amount that is greater than any other surfactant contained by such composition. Similarly, the term “main anionic surfactant” refers to an anionic surfactant that is present in a composition at an amount that is greater than any other anionic surfactant contained by such composition.

As used herein, the term “majority surfactant” refers to a surfactant that is present in a composition at an amount that is at least 50% by weight of the total surfactant content in such composition. Similarly, the term “majority anionic surfactant” refers to an anionic surfactant that is present in a composition at an amount that is at least 50% by weight of the total anionic surfactant content in such composition.

As used herein, the term “alkyl” means a hydrocarbyl moiety which is branched or unbranched, substituted or unsubstituted. Included in the term “alkyl” is the alkyl portion of acyl groups.

As used herein, the term “alkylenoxy group”, “alkyleneoxy group” or “alkoxylate group” are interchangeably used to mean an alkylene oxide moiety in which the alkylene may contain 2 to 4 carbon atoms.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Dye Fixatives

The dye fixatives of the present invention are cationic polymers. Without being bound by any theory, it is believed that such dye fixatives with positive charges can bind dyes with negative charges through charge interactions and then prevent the dyes out of the textiles or prevent the redeposition of the dyes onto a different colored textile. Particularly, the dye fixatives may be selected from the group consisting of reaction products of: i) polyamines with cyanamides and organic and/or inorganic acids, ii) cyanamides with aldehydes and ammonium salts, iii) cyanamides with aldehydes and amines, or iv) amines with epichlorohydrin. Preferably, the dye fixative may be selected from the group consisting of reaction products of amines with epichlorohydrin in which the amines are primary, secondary or tertiary amines. More preferably, the dye fixative may be selected from the group consisting of reaction products of dimethylamine with epichlorohydrin. Most preferably, the dye fixative may be poly(2-hydroxypropyldimethylammonium chloride), also called poly(dimethylamine-co-epichlorohydrin), for example the polymer commercially available under the trade name of TEXCARE DFC 6 from Clariant.

The term of “amines” comprises monoamines and polyamines. The monoamines used herein may be primary, secondary and tertiary amines. They may be aliphatic amines, for example dialkylamines, especially dimethylamine, alicyclic amines, for example cyclohexylamine, and aromatic amines, for example aniline. However, the amines used herein may also simultaneously have aliphatic, alicyclic and aromatic substituents. In addition, it is also possible to use heterocyclic compounds, for example pyridine. The term “polyamines” herein includes, for example diamines, triamines, tetraamines, etc, and also the analogous N-alkylpolyamines and N,N-dialkylpolyamines. Examples thereof are ethylenediamine, propylenediamine, butylenediamine, pentylenediamine, hexylenediamine, diethylenetriamine, triethylenetetraamine and higher polyamines. Particularly preferred polyamines may be ethylenediamine, diethylenetriamine and dimethylaminopropylamine. The ammonium salts are salts of ammonia, especially ammonium chloride or the abovementioned amines or polyamines with different inorganic or organic acids, or else quaternary ammonium salts.

The cyanamides may be cyanamide or dicyandiamide. Aldehydes used herein may include, for example, aliphatic aldehydes such as formaldehyde, acetaldehyde, propionaldehyde, butyraldehyde; dialdehydes, for example glyoxal; unsaturated aldehydes, for example acrolein, crotonaldehyde and aromatic aldehydes, for example benzaldehyde. Particularly preferred aldehydes may be aliphatic aldehydes such as formaldehyde.

The dye fixatives used herein may also be homo- and copolymers based on diallyldimethylammonium chloride (DADMAC). Copolymers based on DADMAC contain, as further components, other vinylic monomers, for example vinylimidazole, vinylpyrrolidone, vinyl alcohol, vinyl acetate, (meth) acrylic acid/ester, acrylamide, styrene, styrenesulfonic acid, acrylamidomethylpropanesulfonic acid (AMPS), etc. Homopolymers based on DADMAC are obtainable under the trade names Dodigen® 3954, Dodigen 4033 and Genamin PDAC (from Clariant).

Preferably, the dye fixative suitable for use in the present disclosure can be selected from the group consisting of reaction products of amines with epichlorohydrin in which the amines are primary, secondary or tertiary amines. More preferably, the dye fixative suitable for use in the present invention can be selected from the group consisting of reaction products of dimethylamine with epichlorohydrin. Most preferably, the dye fixative may be poly(2-hydroxypropyldimethylammonium chloride).

In one embodiment, the dye fixative is poly(2-hydroxypropyldimethylammonium chloride) of formula (I):

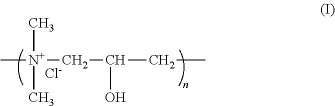

wherein n is an integer from 5 to 1000.

The dye fixative in the composition according to the present disclosure may be present in an amount ranging from 0.02% to 2.5%, preferably from 0.05% to 2%, more preferably from 0.1% to 1.5%, most preferably from 0.15% to 0.9%, for example 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.1%, 1.2%, 1.5%, 1.7%, 2.0%, 2.2%, 2.5% or any ranges therebetween, by weight of the composition.

### Cleaning Polymers

The cleaning polymer may be selected from the group consisting of a polyalkylene imine polymer, a polyalkylene oxide polymer, and any combinations thereof.

In some embodiments, said cleaning polymer is a polyalkylene imine polymer comprising a core structure and a plurality of alkoxylate groups,
wherein:
   the core structure comprises
i) a polyalkylenimine structure comprising, in condensed form, repeating units of formulae (I), (II), (III) and (IV):

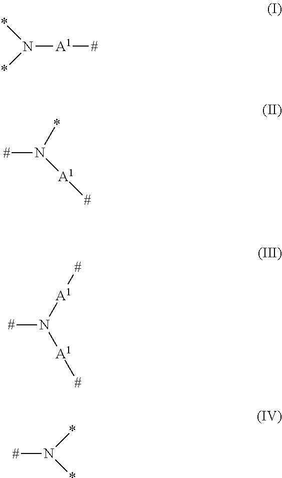

wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol; or
ii) a polyalkanolamine structure of the condensation products of at least one compound selected from N-(hydroxyalkyl)amines of formulae (I.a) and/or (I.b),

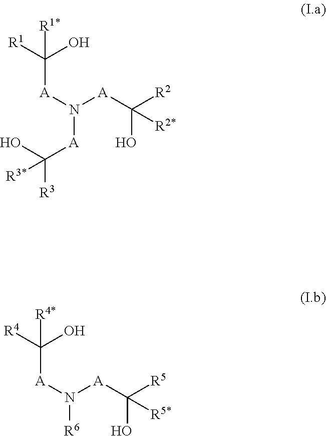

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted; and
the plurality of alkylenoxy groups are independently selected from alkylenoxy units of the formula (V)

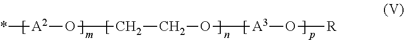

wherein: * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 20 to about 50; and p has an average value in the range of from about 10 to about 40,

In some embodiments, said cleaning polymer is a polyalkylene oxide polymer which is a polyalkylene graft copolymer comprising:
a) polyalkylene oxide component as a graft base, which has a number average molecular weight of from 1000 to 20,000 Daltons and is based on ethylene oxide, propylene oxide, butylene oxide or mixtures thereof,
b) polyvinyl ester component as side chains, which is derived from a saturated monocarboxylic acid containing from 1 to 6 carbon atoms and/or a methyl or ethyl ester of acrylic or methacrylic acid, and
c) polyvinyl five-membered nitrogen heterocycle as side chains.

In some embodiments, said cleaning polymer is a polyalkylene oxide polymer which is a polyalkylene graft copolymer comprising:
a) polyalkylene oxide component as a graft base, which has a number average molecular weight of from 1000 to 20,000 Daltons and is based on ethylene oxide, propylene oxide, butylene oxide or mixtures thereof,
b) polyvinyl ester component as side chains, which is derived from a saturated monocarboxylic acid containing from 1 to 6 carbon atoms and/or a methyl or ethyl ester of acrylic or methacrylic acid, and
c) polyvinylpyrrolidone as side chains,
wherein the weight ratio of (a):(c) is from 1:0.1 to 1:2, and
wherein the amount, by weight, of (a) is greater than the amount of (b).

In some embodiments, in the polyalkylene graft copolymer, the polyalkylene oxide has a number average molecular weight of from 2000 to 15,000 Daltons.

In some embodiments, in the polyalkylene graft copolymer, the weight ratio of (a):(c) is from 1.0:0.1 to 1.0:0.99, preferably from 1.0:0.3 to 1.0:0.9.

In some embodiments, in the polyalkylene graft copolymer, from 1.0 mol % to 60 mol %, preferably from 20 mol % to 60 mol %, more preferably from 30 mol % to 50 mol % of the grafted-on monomers of component (c) are hydrolysed.

In some embodiments, the polyalkylene graft copolymer has a weight average molecular weight of from 4,000 Da to 100,000 Da, preferably 5,000 Da to 100,000 Da, more preferably from 5,000 Da to 50,000 Da, most preferably from 8,000 Da to 20,000 Da.

In some embodiments, said cleaning polymer is a polyalkylene oxide polymer which is a polyalkylene graft copolymer comprising:
a) polyalkylene oxide component as a graft base; and
b) vinyl ester component as side chains.

In some embodiments, the polyalkylene graft copolymer has an average of greater than 0 to less than or equal to 1 graft site per 50 alkylene oxide units.

In some embodiments, the polyalkylene graft copolymer has from 20% to 70%, preferably from 25% to 60%, by weight of said polymer of the polyalkylene oxide component and from 30% to 80%, preferably from 40% to 75%, by weight of said polymer of the vinyl ester component.

In some embodiments, the polyalkylene graft copolymer has a mean molar mass Mw of from 3,000 to 60,000, preferably from 6,000 to 45,000.

In some embodiments, the polyalkylene graft copolymer has a polydispersity of less than or equal to 3.

In some embodiments, the polyalkylene graft copolymer comprises less than or equal to 10% by weight of the polyvinyl ester in ungrafted form.

In some embodiments, the polyalkylene graft copolymer comprises side chains consisting of the vinyl ester component.

### Anionic Surfactant

The laundry detergent composition of the present invention may comprise an anionic surfactant system. Particularly, the laundry detergent composition of the present invention may comprise from 0.1% to 50% by weight of the composition, of an anionic surfactant system.

The C₆-C₂₀ linear alkylbenzene sulfonate surfactant (LAS) is a required anionic surfactant for the laundry detergent composition of the present invention. In one embodiment, LAS is C₁₀-C₁₆ LAS, preferably C₁₂-C₁₄ LAS.

The LAS is normally prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. By varying the precise alkylation catalyst, it is possible to widely vary the position of covalent attachment of benzene to an aliphatic hydrocarbon chain. Accordingly, the LAS herein can vary widely in 2-phenyl isomer and/or internal isomer content.

The anionic surfactant suitable for use in the present disclosure may further comprise C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), or any combinations thereof. For example, the laundry detergent composition may contain a C₆-C₂₀ alkyl alkoxy sulfates (AAₓS), wherein x is about 1-30, preferably about 1-15, more preferably about 1-10, most preferably x is about 1-3. The alkyl chain in such AAₓS can be either linear or branched, with mid-chain branched AAₓS surfactants being particularly preferred. A preferred group of AAₓS include C₁₂-C₁₄ alkyl alkoxy sulfates with x of about 1-3. The amount of AAₓS surfactant(s) in the laundry detergent composition of the present invention may range from about 0.05% to about 30%, preferably from about 0.1% to about 20%, more preferably from about 0.5% to about 15%, most preferably from about 1% to about 5%, by weight of the composition.

The anionic surfactant system in the composition according to the present disclosure may be present in an amount ranging from 0.1% to 45%, preferably from 0.5% to 40%, more preferably from 1% to 35%, most preferably from 2% to 30%, for example 2%, 3%, 4%, 5%, 6%, 7%, 8%, 9%, 10%, 15%, 20%, 25%, 30%, 35%, 40%, 45%, 50% or any ranges therebetween, by weight of the composition.

### Nonionic Surfactants (NI)

The laundry detergent composition of the present invention may comprise a nonionic surfactant system. The nonionic surfactant system may comprise a nonionic surfactant selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof. Preferably, the nonionic surfactant system may comprise a C₆-C₂₀ alkoxylated alcohol having a weight average degree of alkoxylation ranging from 1 to 20, preferably from 5 to 15, more preferably from 7 to 10. More preferably, the nonionic surfactant system may comprise a C₈-C₁₈ ethoxylated alcohol having a weight average degree of ethoxylation ranging from 1 to 20, preferably from 5 to 15, more preferably from 7 to 10.

Non-limiting examples of nonionic surfactants suitable for use herein include: C₁₂-C₁₈ alkyl ethoxylates, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from about 1 to about 30; alkylpolysaccharides, specifically alkylpolyglycosides; polyhydroxy fatty acid amides; and ether capped poly(oxyalkylated) alcohol surfactants. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between about 1 and about 20. Such alkoxylated ester surfactants include the fatty methyl ester ethoxylates (MEE) and are well-known in the art.

In a particular embodiment, the alkoxylated nonionic surfactant contained by the laundry detergent composition of the present invention is a C₆-C₂₀ alkoxylated alcohol, preferably C₈-C₁₈ alkoxylated alcohol, more preferably C₁₀-C₁₆ alkoxylated alcohol. The C₆-C₂₀ alkoxylated alcohol is preferably an alkyl alkoxylated alcohol with an average degree of alkoxylation of from about 1 to about 50, preferably from about 3 to about 30, more preferably from about 5 to about 20, even more preferably from about 5 to about 9. The alkoxylation herein may be ethoxylation, propoxylation, or a mixture thereof, but preferably is ethoxylation. In one embodiment, the alkoxylated nonionic surfactant is C₆-C₂₀ ethoxylated alcohol, preferably C₈-C₁₈ alcohol ethoxylated with an average of about 5 to about 20 moles of ethylene oxides, more preferably C₁₀-C₁₆ alcohol ethoxylated with an average of about 5 to about 9 moles of ethylene oxides. The most preferred alkoxylated nonionic surfactant is C₁₂-C₁₄ alcohol ethoxylated with an average of about 7 or 9 moles of ethylene oxide, or C₁₂-C₁₅ alcohol ethoxylated with an average of about 7 moles of ethylene oxide, e.g., Neodol®25-7 commercially available from Shell.

The nonionic surfactant system in the composition according to the present disclosure may be present in an amount ranging from 1% to 45%, preferably from 2% to 40%, more preferably from 3% to 35%, most preferably from 4% to 30%, for example 4%, 5%, 6%, 7%, 8%, 9%, 10%, 11%, 12%, 13%, 14%, 15%, 20%, 25%, 30%, 35%, 40%, 45% or any ranges therebetween, by weight of the composition.

### Other Ingredients

The laundry detergent composition herein may comprise adjunct ingredients. Suitable adjunct materials include but are not limited to: builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### METHOD OF USE

Another aspect of the present invention is directed to a method of using the laundry detergent composition to treat a fabric. Such method can deliver a color protection benefit. The method comprises the step of administering from 5 g to 120 g of the above-mentioned laundry detergent composition into a laundry washing basin comprising water to form a washing solution. The washing solution in a laundry washing basin herein preferably has a volume from 1 L to 50 L, alternatively from 1 L to 20 L for hand washing and from 20 L to 50 L for machine washing. The temperatures of the laundry washing solution preferably range from 5° C. to 60° C.

The dosing amount in the method herein may be different depending on the washing type. In one embodiment, the method comprises administering from about 5 g to about 60 g of the laundry detergent composition into a hand washing basin (e.g., about 2-4 L). In an alternative embodiment, the method comprises administering from about 5 g to about 100 g, preferably from about 10 g to about 65 g of the laundry detergent composition into a washing machine (e.g., about 30-45 L).

### Test Method

### Test 1: Whitening Performance Test

In order to determine Whiteness performance, a test is conducted by using Tergotometer (Model: RHLQ IV, from China Daily Chemical Industry Research Institute) as below:
Mixed soil composition: Body soil (JB03)/Arizona dust/BJ clay (2500 ppm/500 ppm/3750 ppm, 37%/7%/56%)
Water volume: 0.8 L
Water type: city water
HDL Concentration: 5000 ppm
Fabric Tracer: 10 cm×10 cm with-brightener CW98 (100% Heavy Cotton, purchased from Danxin Textile Co. Beijing, China) 2 pieces, or 10 cm×10 cm with-brightener PCW13(100% Heavy Cotton, purchased from Danxin Textile Co. Beijing, China), which were pre-stripped with China National Standard powder detergent (from Taiyuan, China) in DI water by 6 times

Measure the L*ab (and then calculate ΔWI) of the fabric tracers before washing according to the test method below.
1, Add city water
2, Add HDL and dissolve for 3 minutes.
3, Add the mixed soil composition and dissolve for 3 minutes.
4, Put in fabric tracers and start stirring (main wash).
5, The main wash time is 16 minutes.
6, Remove the fabrics from the wash container and squeeze dry
7, Add city water, put in fabric tracers and start stirring (rinse)
8, The rinse time is 3 minutes.
10, Remove the fabrics from the rinse container and dry in natural air.
11, Polaris was used to measure L/A/B and calculate Whitening Index (WI). Then, ΔWI is calculated in which the sample without any dye fixative or cleaning polymer was used as a benchmark.

### EXAMPLES

### Example 1: Improved Whitening Performance Achieved by Laundry Detergent Composition Containing Dye Fixative and Cleaning Polymer

Eight (8) sample liquid laundry detergent compositions were prepared containing the following ingredients. Sample 1 comprises no dye fixative or cleaning polymer, Sample 2 comprises a dye fixative only, Samples 3, 5 and 7 comprise cleaning polymers only and Samples 4, 6 to 8 comprise combinations of the dye fixative and the cleaning polymer.

TABLE 1

| Ingredients (weight %) | Sample 1 | Sample 2 | Sample 3 | Sample 4 |
|---|---|---|---|---|
| Dye fixative¹ | — | 0.4% | — | 0.4% |
| Cleaning polymer A² | — | — | 0.5% | 0.5% |
| Cleaning polymer B³ | — | — | — | — |
| Cleaning polymer C⁴ | — | — | — | — |
| C₁₂₋₁₄EO₇ | 12% | 12% | 12% | 12% |
| C₁₂₋₁₄AE₃S | 4% | 4% | 4% | 4% |
| C₁₁₋₁₃LAS | 7% | 7% | 7% | 7% |
| Dodecyldimethyl amine | 1% | 1% | 1% | 1% |
| oxide | | | | |
| Water | Balance | Balance | Balance | Balance |
| Ingredients (weight %) | Sample 5 | Sample 6 | Sample 7 | Sample 8 |
| Dye fixative¹ | — | 0.4% | — | 0.4% |
| Cleaning polymer A² | — | — | — | — |
| Cleaning polymer B³ | 0.2% | 0.2% | — | — |
| Cleaning polymer C⁴ | — | — | 0.4% | 0.4% |
| C₁₂₋₁₄EO₇ | 12% | 12% | 12% | 12% |
| C₁₂₋₁₄AE₃S | 4% | 4% | 4% | 4% |
| C₁₁₋₁₃LAS | 7% | 7% | 7% | 7% |
| Dodecyldimethyl amine | 1% | 1% | 1% | 1% |
| oxide | | | | |
| Water | Balance | Balance | Balance | Balance |

¹Poly(2-hydroxypropyldimethylammonium chloride) commercially available under the trade name of TEXCARE DFC 6 from Clariant.
²Polyalkylene oxide copolymer with PVP/PVAc-g-PEG at a weight ratio of 20:30:50 ratio with a weight average molecular weight 16,800 Dalton available from BASF.
³Polyvinyl acetate grafted polyethylene oxide copolymer having a polyethylene oxide backbone and multiple polyvinyl acetate side chains, supplied by BASF.
⁴Polyalkylene imine polymer: Polyethyleneimines (PEI) polymer ethoxylated (20-50) and propoxylated, (10-40) available from BASF

In accordance with Test 1: Whitening performance test as described hereinabove, the ΔWI for these samples was measured as a measurement of whitening performance in three tests for three different cleaning polymers. The higher ΔWI indicates the better whitening performance.

The results are shown in the Tables 2 to 4 below. Surprisingly, the inventors discovered that the combinations of the dye fixative and the cleaning polymers tested show significantly improved whitening performance than when the cleaning polymer and the dye fixative are used alone.

TABLE 2

| | Sample 1 | Sample 2 | Sample 3 | Sample 4 |
|---|---|---|---|---|
| ΔWI (CW98) | Benchmark | 4.4 | 7.2 | 18.1 |
| ΔWI (PCW13) | Benchmark | 1.5 | 2.9 | 15.3 |
| Notes | No dye fixative | Dye | Cleaning | Combination of |
| | or cleaning | fixative | polymer | dye fixative |
| | polymer | only | only | and cleaning |
| | | | | polymer |

TABLE 3

| | Sample 1 | Sample 2 | Sample 5 | Sample 6 |
|---|---|---|---|---|
| ΔWI (CW98) | Benchmark | 1.1 | 2.1 | 9.4 |
| ΔWI (PCW13) | Benchmark | 7.1 | 5.4 | 19.1 |
| Notes | No dye fixative | Dye | Cleaning | Combination of |
| | or cleaning | fixative | polymer | dye fixative |
| | polymer | only | only | and cleaning |
| | | | | polymer |

TABLE 4

| | Sample 1 | Sample 2 | Sample 7 | Sample 8 |
|---|---|---|---|---|
| ΔWI (CW98) | Benchmark | 2.4 | 5.9 | 15.5 |
| ΔWI (PCW13) | Benchmark | 5.6 | 2.9 | 15.9 |
| Notes | No dye fixative | Dye | Cleaning | Combination of |
| | or cleaning | fixative | polymer | dye fixative |
| | polymer | only | only | and cleaning |
| | | | | polymer |

### Example 2: Exemplary Formulations of Liquid Laundry Detergent Compositions Containing Dye Fixative and Cleaning Polymer

The following liquid laundry detergent compositions shown in Table 5 are made comprising the listed ingredients in the listed proportions (weight %).

TABLE 5

| Ingredients | | | | | | |
|---|---|---|---|---|---|---|
| (weight %) | A | B | C | D | E | F |
| C₁₂₋₁₄AE₁₋₃S | 4 | 1.5 | 3 | 1 | 4 | 1.5 |
| C₁₁₋₁₃LAS | 2 | 3 | 5 | 1 | 2 | 3 |
| C₁₄₋₁₅EO₇ | 10 | 8.5 | 15 | 12 | 5 | — |
| C₁₂₋₁₄EO₇ | — | — | — | — | — | 8 |
| APG | — | — | — | — | 5 | 4 |
| MEE | — | — | — | 5 | — | — |
| Dodecyldimethyl | 1.5 | — | 0.5 | — | 1.5 | — |
| amine oxide | | | | | | |
| Dye fixative¹ | 0.5 | 0.9 | 0.7 | 0.3 | 0.5 | 0.9 |
| Cleaning | 0.2 | — | — | 0.8 | — | — |
| polymer A² | | | | | | |
| Cleaning | — | — | 0.1 | — | — | 0.9 |
| polymer B³ | | | | | | |
| Cleaning | — | 0.8 | — | — | 0.2 | — |
| polymer C⁴ | | | | | | |
| Citric acid | 2.4 | 0.5 | 4.8 | 0.6 | — | 2 |
| C₁₂-C₁₈ fatty acid | 3.2 | 1.2 | 2.2 | 2 | 1.5 | 1.2 |
| Na-DTPA | 1 | 0.05 | 0.5 | 0.18 | 0.06 | 0.2 |
| Sodium cumene | — | — | — | 4.42 | — | — |
| sulphonate | | | | | | |
| Ethanol | — | — | — | 1.74 | — | — |
| Calcium | — | — | 0.06 | 0.03 | — | — |
| chloride | | | | | | |
| Magnesium | — | — | — | 0.01 | — | — |
| chloride | | | | | | |
| Silicone | — | 0.0025 | 0.0025 | 0.0025 | — | 0.0025 |
| emulsion | | | | | | |
| Sodium | 1.4 | — | — | — | 1.4 | — |
| polyacrylate | | | | | | |
| NaOH | Up to | Up to | Up to | Up to | Up to | Up to |
| | pH 8 | pH 8 | pH 8 | pH 8 | pH 8 | pH 8 |
| Na Formate | — | — | — | 0.02 | — | — |
| Tinosan ® | 0.05 | 0.07 | 0.5 | 0.07 | 0.05 | 0.07 |
| HP100 | | | | | | |
| Brightener | — | 0.06 | 0.06 | 0.04 | — | 0.06 |
| Protease | — | — | 0.45 | 0.29 | — | — |
| Amylase | — | — | 0.08 | — | — | — |
| Dye | — | 0.002 | 0.002 | 0.001 | — | 0.002 |
| Perfume oil | — | 0.6 | 0.6 | 0.57 | — | 0.6 |
| Water | Balance | Balance | Balance | Balance | Balance | Balance |

1 Poly(2-hydroxypropyldimethylammonium chloride) commercially available under the trade name of TEXCARE DFC 6 from Clariant.
2 Polyalkylene oxide copolymer with PVP/ PVAc-g-PEG at a weight ratio of 20:30:50 ratio with a weight average molecular weight 16,800 Dalton available from BASF.
3 Polyvinyl acetate grafted polyethylene oxide copolymer having a polyethylene oxide backbone and multiple polyvinyl acetate side chains, supplied by BASF.
4 Polyalkylene imine polymer: Polyethyleneimines (PEI) polymer ethoxylated (20-50) and propoxylated,(10-40) available from BASF

### Example 3: Exemplary Formulations of Unite Dose Laundry Detergent Compositions Containing a Dye Fixative and Cleaning Polymer

The exemplary formulations shown in Table 6 are made for unit dose laundry detergent. These compositions are encapsulated into compartment(s) of the unit dose by using a polyvinyl-alcohol-based film.

TABLE 6

| Ingredients | | | | | | | |
|---|---|---|---|---|---|---|---|
| (weight %) | G | H | I | J | K | L | M |
| C₁₁₋C₁₃ LAS | 8 | 6 | 5 | 1 | 8 | 6 | 5 |
| C₁₂₋C₁₄AE₃S | 6 | 10 | 5 | 2 | 6 | 10 | 5 |
| C₁₄₋C₁₅EO₇ | — | 6 | — | — | 9 | 10 | 11 |
| C₁₂₋C₁₄EO₇ | 18 | 25 | 16 | 18 | 9 | 15 | 5 |
| Dodecyldimethyl | 5 | — | 2 | — | — | 7 | 2 |
| amine oxide | | | | | | | |
| Dye Fixative¹ | 2 | 3.5 | 1 | 5 | 2 | 3.5 | 1 |
| Cleaning | 3 | — | — | — | 5 | — | — |
| polymer A² | | | | | | | |
| Cleaning | — | — | — | 1 | — | 2 | 6 |
| polymer B³ | | | | | | | |
| Cleaning | — | 2 | 4 | — | — | — | — |
| polymer C⁴ | | | | | | | |
| Citric acid | 0.5 | 0.7 | 1.1 | 0.5 | 0.5 | 0.7 | 1.1 |
| C₁₂₋C₁₈ fatty acid | 0.5 | 2.4 | 0.5 | 4.8 | 0.5 | 2.4 | 0.5 |
| Sodium cumene | 1.3 | 1.3 | 1.3 | 1.3 | 1.3 | 1.3 | 1.3 |
| sulphonate | | | | | | | |
| Tinosan ®HP100 | 0.09 | 1 | 0.05 | 0.5 | — | — | — |
| Solvent | Balance | Balance | Balance | Balance | Balance | Balance | Balance |

1 Poly(2-hydroxypropyldimethylammonium chloride) commercially available under the trade name of TEXCARE DFC 6 from Clariant.
2 Polyalkylene oxide copolymer with PVP/ PVAc-g-PEG at a weight ratio of 20:30:50 ratio with a weight average molecular weight 16,800 Dalton available from BASF.
3 Polyvinyl acetate grafted polyethylene oxide copolymer having a polyethylene oxide backbone and multiple polyvinyl acetate side chains, supplied by BASF.
4 Polyalkylene imine polymer: Polyethyleneimines (PEI) polymer ethoxylated (20-50) and propoxylated,(10-40) available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition, comprising:
a) from 0.01% to 10%, by weight of the composition, of a dye fixative wherein said dye fixative is selected from the group consisting of reaction products of amines with epichlorohydrin in which the amines are primary, secondary or tertiary amines;
b) from 0.01% to 10%, by weight of the composition, of a cleaning polymer wherein said cleaning polymer is selected from the group consisting of a polyalkylene imine polymer, a polyalkylene oxide polymer, and any combinations thereof;
c) from 0.1% to 70%, by weight of the composition, of a surfactant system,
wherein the polyalkylene imine polymer comprises a core structure and a plurality of alkoxylate groups, wherein:
the core structure comprises
i) a polyalkylenimine structure comprising, in condensed form, repeating units of formulae (I), (II), (III) and (IV): 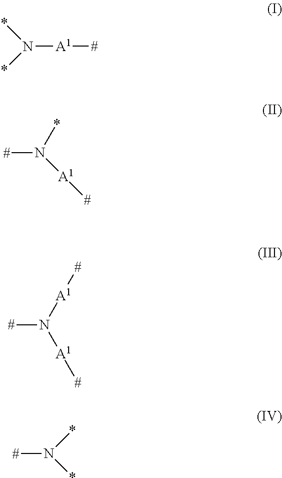
wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol; or
ii) a polyalkanolamine structure of the condensation products of at least one compound selected from N-(hydroxyalkyl)amines of formulae (I.a) and/or (I.b), 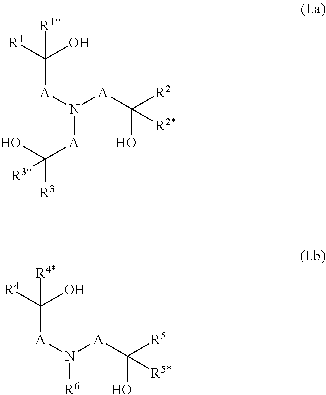
wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted; and
the plurality of alkylenoxy groups are independently selected from alkylenoxy units of the formula (V) 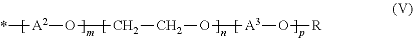
wherein: * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 10 to about 50; and p has an average value in the range of from about 10 to about 50,
wherein said polyalkylene oxide polymer is a polyalkylene graft copolymer comprising polyalkylene oxide component as a graft base, which has a number average molecular weight of from 1000 to 20,000 Daltons and is based on ethylene oxide, propylene oxide, butylene oxide or mixtures thereof, and polyvinyl ester component and/or polyvinyl five-membered nitrogen heterocycle component as side chains.

2. The laundry detergent composition according to claim 1, wherein said cleaning polymer is a polyalkylene imine polymer comprising a core structure and a plurality of alkoxylate groups, wherein:
the core structure comprises
i) a polyalkylenimine structure comprising, in condensed form, repeating units of formulae (I), (II), (III) and (IV): 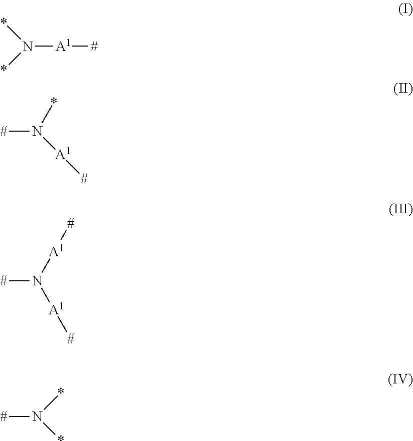
wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol; or
ii) a polyalkanolamine structure of the condensation products of at least one compound selected from N-(hydroxyalkyl)amines of formulae (I.a) and/or (I.b), 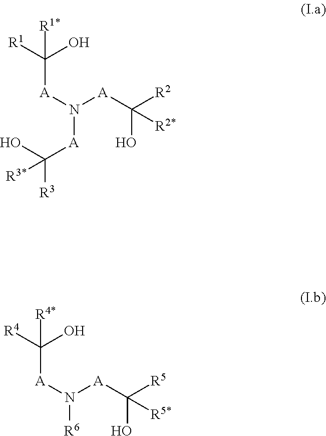
wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted; and
the plurality of alkylenoxy groups are independently selected from alkylenoxy units of the formula (V) 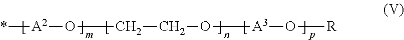
wherein: * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 20 to about 50; and p has an average value in the range of from about 10 to about 40.

3. The laundry detergent composition according to claim 1, wherein said cleaning polymer is a polyalkylene oxide polymer which is a polyalkylene graft copolymer comprising:
a) polyalkylene oxide component as a graft base, which has a number average molecular weight of from 1000 to 20,000 Daltons and is based on ethylene oxide, propylene oxide, butylene oxide or mixtures thereof,
b) polyvinyl ester component as side chains, which is derived from a saturated monocarboxylic acid containing from 1 to 6 carbon atoms and/or a methyl or ethyl ester of acrylic or methacrylic acid, and
c) polyvinyl five-membered nitrogen heterocycle as side chains.

4. The laundry detergent composition according to claim 3, wherein said cleaning polymer is a polyalkylene oxide polymer which is a polyalkylene graft copolymer comprising
a) polyalkylene oxide component as a graft base, which has a number average molecular weight of from 1000 to 20,000 Daltons and is based on ethylene oxide, propylene oxide, butylene oxide or mixtures thereof,
b) polyvinyl ester component as side chains, which is derived from a saturated monocarboxylic acid containing from 1 to 6 carbon atoms and/or a methyl or ethyl ester of acrylic or methacrylic acid, and
c) polyvinylpyrrolidone as side chains,
wherein the weight ratio of (a):(c) is from 1:0.1 to 1:2, and
wherein the amount, by weight, of (a) is greater than the amount of (b).

5. The laundry detergent composition according to claim 4, wherein in the polyalkylene graft copolymer, the polyalkylene oxide has a number average molecular weight of from 2000 to 15,000 Daltons, and/or
wherein in the polyalkylene graft copolymer, the weight ratio of (a):(c) is from 1.0:0.1 to 1.0:0.99, preferably from 1.0:0.3 to 1.0:0.9, and/or
wherein in the polyalkylene graft copolymer, from 1.0 mol % to 60 mol %, preferably from 20 mol % to 60 mol %, more preferably from 30 mol % to 50 mol % of the grafted-on monomers of component (c) are hydrolysed, and/or
wherein the polyalkylene graft copolymer has a weight average molecular weight of from 4,000 Da to 100,000 Da.

6. The laundry detergent composition according to claim 1, wherein said cleaning polymer is a polyalkylene oxide polymer which is a polyalkylene graft copolymer comprising:
a) polyalkylene oxide component as a graft base; and
b) vinyl ester component as side chains.

7. The laundry detergent composition according to claim 6, wherein the polyalkylene graft copolymer has an average of greater than 0 to less than or equal to 1 graft site per 50 alkylene oxide units, and/or
wherein the polyalkylene graft copolymer has from 20% to 70, and/or
wherein the polyalkylene graft copolymer has a mean molar mass Mw of from 3,000 to 60,000; and/or
wherein the polyalkylene graft copolymer has a polydispersity of less than or equal to 3; and/or
wherein the polyalkylene graft copolymer comprises less than or equal to 10% by weight of the polyvinyl ester in ungrafted form; and/or
wherein the polyalkylene graft copolymer comprises side chains consisting of the vinyl ester component.

8. The laundry detergent composition according to claim 1, wherein said dye fixative is selected from the group consisting of reaction products of dimethylamine with epichlorohydrin, preferably wherein said dye fixative is poly(2-hydroxypropyldimethylammonium chloride).

9. The laundry detergent composition according to claim 1, wherein said dye fixative is present in an amount ranging from 0.02% to 5%, by weight of the composition; and/or
wherein said cleaning polymer is present in an amount ranging from 0.02% to 5%, by weight of the composition; and/or
wherein said surfactant system is present in an amount ranging from 1% to 45%, by weight of the composition.

10. The laundry detergent composition according to claim 1, wherein said surfactant system comprises an anionic surfactant and/or a non-ionic surfactant;
wherein the anionic surfactant is selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof, and/or wherein the nonionic surfactant is selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof.

11. The laundry detergent composition according to claim 10, wherein the non-ionic surfactant is present as a main surfactant.

12. The laundry detergent composition according to claim 1, wherein said composition is a liquid composition or a unit dose composition.
